(19) United States
(12) Patent Application Publication
(10) Pub. No.: US 2026/0162140 A1
(43) Pub. Date: Jun. 11, 2026

(54) AUTOMATIC ENROLLMENT VIA NFC

(71) Applicants: American Express Travel Related Services Company, Inc., New York, NY (US); AMEX Canda, Inc., North York (CA)

(72) Inventors: Indiana Maria Baltodano, New York, NY (US); Ashley Sjostrom Brailey, Garwood, NJ (US); Alaric M. Eby, Scottsdale, AZ (US); Magdalena McGoldrick, East York (CA)

(21) Appl. No.: 18/971,155

(22) Filed: Dec. 6, 2024

(51) Int. Cl. G06Q 30/0226; G06Q 20/20; G06Q 20/32

(52) U.S. Cl. CPC G06Q 30/0226; G06Q 20/20; G06Q 20/3278

(57) ABSTRACT

Disclosed are various embodiments for automatic enrollment in a merchant rewards program. A point-of-sale (POS) terminal can establish a near field communication (NFC) session with a client device to communicate with the NFC enabled client device. The PoS terminal can then receive a payment instruction for a transaction from the client device, the payment instruction comprising a unique user identifier for a user of the client device. Next, the PoS terminal can determine, based at least in part on the unique user identifier, that a user of the client device is not enrolled in a merchant rewards program. Subsequently, the PoS terminal can send to the client device a request to enroll in the merchant rewards program. Then, the PoS terminal can receive, from the client device, an enrollment authorization. Finally, the PoS terminal can enroll a user of the client device in the merchant rewards program.

### BACKGROUND

Merchants often use loyalty or rewards programs to encourage customers to shop, or continue to shop, with the merchant. For example, loyalty or rewards programs members may be offered exclusive discounts or other benefits not available to customers who are not enrolled. Enrollment in these loyalty or rewards programs often requires users to sign-up and provide personally identifiable information to the merchant as part of the sign-up process.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIGS. 1-3 are drawings depicting an example user experience according to various embodiments of the present disclosure.

FIG. 4 is a drawing of a network environment according to various embodiments of the present disclosure.

FIGS. 5A, 5B, 6A, 6B, and 7 are sequence diagrams illustrating the enrollment and payment process within the network environment of FIG. 4 according to various embodiments of the present disclosure.

### DETAILED DESCRIPTION

Disclosed are various approaches for enrolling a user in a merchant loyalty or rewards program as part of the payment process. When making a purchase in person, consumers typically have to provide their information to the sales associate at the register or input their information manually in a payment or point-of-sale (POS) terminal. This process has a number flaws.

First, there are privacy concerns. Users are required to trust the sales associate to not copy or misuse their personally identifying information that they supply when signing up for the rewards program. Second, users are exposed to other customers or passers by stealing their personally identifying information as they enter it manually in a payment or PoS terminal or provided it manually or verbally to a sales associate.

Second, these manual processes are often time-consuming and error prone. It can take significant time to manually fill out a form or input information into a terminal. Second, data entry is often error-prone, especially if the payment or PoS terminal lacks a keyboard or other mechanism for easily entering information.

Accordingly, various embodiments of the present disclosure allow for users to consent to automatically enroll in a merchant's rewards program at the time of payment. A user with a mobile wallet application on his or her client device can tap the client device to the payment or PoS terminal to make a payment. The mobile wallet can exchange information with the payment or PoS terminal, including both payment information to complete the transaction and personal information to determine (1) if the user is currently or already enrolled in a rewards program; (2) prompt the user to enroll in the rewards program if he or she desires to; and (3) automatically apply any offers to reduce the cost of the transaction. The use of near field communications (NFC) allows for enrollment to leverage existing payment technologies and to also exchange data in a secure and reliable manner.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

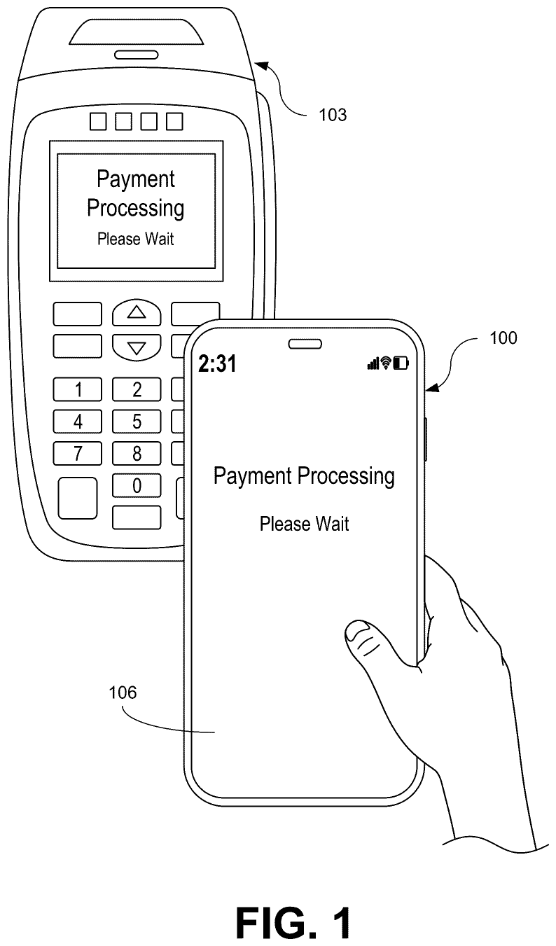

FIGS. 1-3 depict an illustrative example of a user experience according to various embodiments of the present disclosure. Although FIGS. 1-3 depict one example of a user experience, other user experiences are also encompassed by the various embodiments of the present disclosure.

In FIG. 1, a user can place his or her client device 100 in proximity to a point of sale (PoS) terminal 103 to make a payment to a merchant. For example, the client device 100 and the PoS terminal 103 could include wireless radios that allow for direct communication between other devices using near-field communication (NFC), ultra-wideband (UWB), BLUETOOTH®, etc. This might occur as part of a “tap-to-pay” experience where a user can make a payment by using a wallet application installed on his or her phone to make a payment instead of using a payment card (e.g., credit card or debit card), check, or cash. When the client device 100 is placed within proximity to the PoS terminal 103, the PoS terminal 103 can detect the presence of the client device 100. The client device 100 and the PoS terminal 103 can then exchange transaction data and payment data (e.g., via NFC, UWB, or BLUETOOTH) in order to make a payment and complete a transaction. Information about the transaction, including its status (e.g., processing) could be shown on the display 106 of the client device 100.

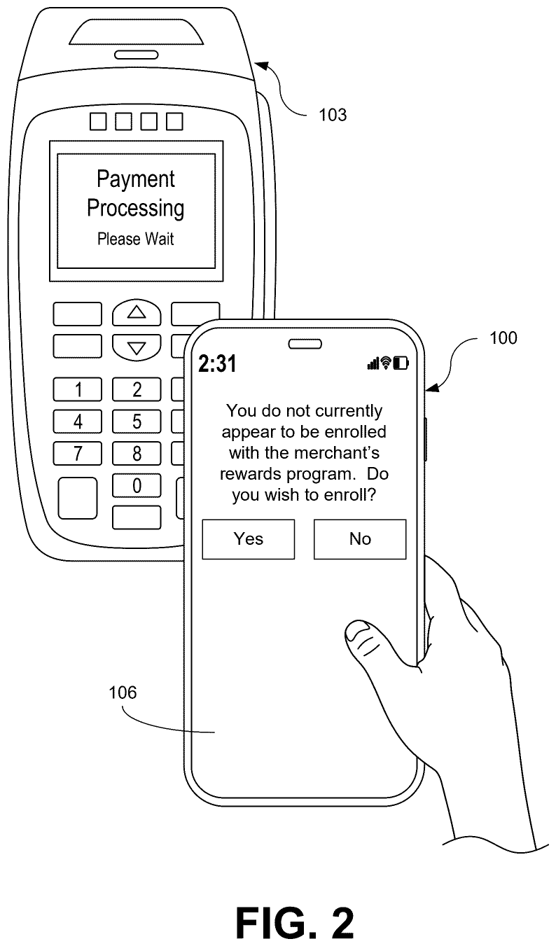

In FIG. 2, the user could be prompted on the client device 100 to enroll with the merchant's rewards program. As discussed later, this requested could be received from a variety of sources. For example, the PoS terminal 103 could send the request to the client device 100 (e.g., via an NFC, UWB, or BLUETOOTH connection between the devices). The request could then be shown on the display 106 of the client device 100. As another example, the PoS terminal 103 could send the request to the issuer of the payment instrument being used for the transaction or the developer of the wallet application used on the client device 100. The issuer or developer could then push or otherwise send the request to the client device 100, which then shows the request on the display 106.

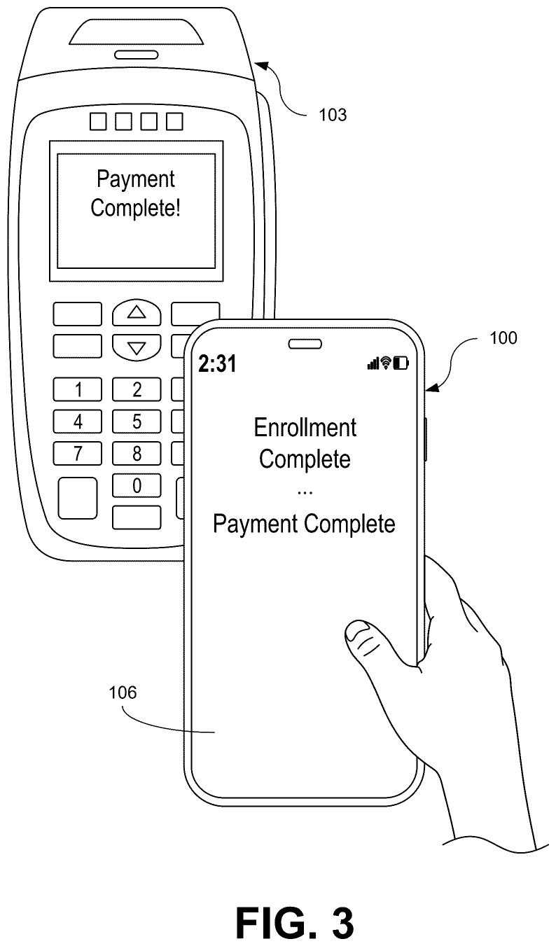

Assuming that the user has consented to enroll in the rewards program (e.g., as depicted in FIG. 2), then the user could be presented with a confirmation of enrollment as shown in FIG. 3. For example, the client device 100 could show the enrollment is complete and that payment has been completed on the display 106. Simultaneously, the PoS terminal 103 could show the same or similar information about the transaction. The enrollment authorization could occur, for example, after the client device 100 has sent relevant information to the PoS terminal 103 to allow the user to be enrolled in the merchant rewards program.

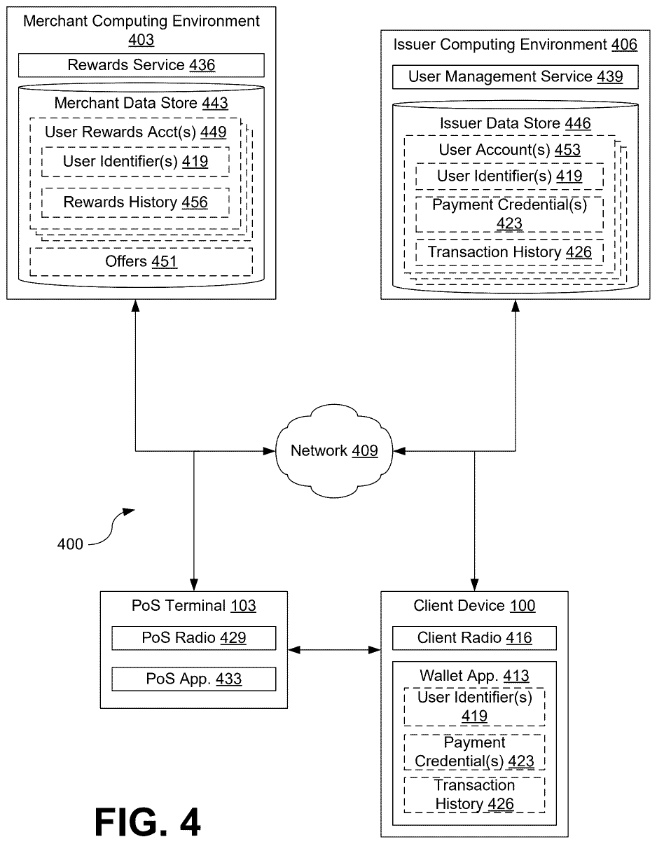

Moving on to FIG. 4, shown is a network environment 400 according to various embodiments. The network environment 400 can include a client device 100, a PoS terminal 103, a merchant computing environment 403, an issuer computing environment 406. The merchant computing environment 403 can represent a computing environment operated by a merchant to support the operations of the PoS terminal 103. The issuer computing environment 406 can be operated by the issuer of a payment instrument used to make a payment with the merchant operating the PoS terminal 103, which can include providing support to the operation of the wallet application 413 executed by the client device 100.

The client device 100, PoS terminal 103, merchant computing environment 403, and issuer computing environment 406 can be in data communication with each other via a network 409. The client device 100 and the PoS terminal 103 can be separately in direct data communication with each other (e.g., via an NFC, UWB, or BLUETOOTH connection).

The network 409 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 409 can also include a combination of two or more networks 409. Examples of networks 409 can include the Internet, intranets, extranets, virtual private networks (VPNs), and similar networks.

A computing environment, such as the merchant computing environment 403 or the issuer computing environment 406, can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, a computing environment can employ a plurality of computing devices that can be arranged in one or more server banks or computer banks or other arrangements. Such computing devices can be located in a single installation or can be distributed among many different geographical locations. For example, the computing environment can include a plurality of computing devices that together can include a hosted computing resource, a grid computing resource or any other distributed computing arrangement. In some cases, the computing environment can correspond to an elastic computing resource where the allotted capacity of processing, network, storage, or other computing-related resources can vary over time.

Although depicted separately for the purposes of clarity, in some implementations, the merchant computing environment 403 and the issuer computing environment 406 could be a single computing environment. This could occur, for example, when the operators of the merchant computing environment 403 and the issuer computing environment 406 utilize computing capacity offered for lease or sale by a third-party (e.g., Amazon Web Services (AWS), Google Cloud Compute (GCP), Microsoft Azure, etc.).

The client device 100 is representative of a plurality of client devices that can be coupled to the network 409 or be in direct data communication with the PoS terminal 103. The client device 100 can include any processor-based computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), or other devices with like capability.

The client device 100 can include one or more displays 106 (FIGS. 1-3). Examples of such displays 106 can include liquid crystal displays (LCDs), gas plasma-based flat panel displays, organic light emitting diode (OLED) displays, electrophoretic ink (“E-ink”) displays, projectors, or other types of display devices. In some instances, the display 106 can be a component of the client device 100 or can be connected to the client device 100 through a wired or wireless connection.

The client device 100 can also have additional hardware components, such as one or more client radios 416. In some implementations, a client device 100 can have separate client radios 416 to communicate using different wireless protocols or mediums. For example, even though both IEEE 802.11 wireless networks (i.e., WI-FI) and BLUETOOTH operate on the same 2.4 Ghz frequencies, the client device 100 could have separate radios and chipsets for communicating via WI-FI and BLUETOOTH. In other examples, however, a single client radio 416 could be used to communicate using WI-FI and BLUETOOTH. Similarly, separate client radios 416 or the same client radio 416 could be used to communicate using other wireless communications methodologies (e.g., NFC, UWB, etc.). Therefore, while only a single client radio 416 is depicted in FIG. 4 to simplify the drawings, a client device 100 could have one or more client radios 416 as appropriate for different embodiments or implementations of a client device 100.

The client device 100 can be configured to execute various applications such as a wallet application 413. The wallet application 413 can be executed to provide payment functionality for the client device 100 when the client device 100 is in direct data communication with the PoS terminal 103 (e.g., via NFC, UWB, BLUETOOTH, etc.). For example, the wallet application 413 can be configured to respond to requests for payment information from the PoS terminal 103 in order to allow a user to complete a transaction. This could be accomplished, for example, by the wallet application 413 implementing a host card emulation (HCE) architecture in some embodiments of the present disclosure. The wallet application 413 can also be configured to respond to requests for the user to enroll in a merchant reward program according to various embodiments of the present disclosure and to obtain the consent of the user for the enrollment requests. Other features can also be implemented and/or provided by the wallet application 413 according to various embodiments of the present disclosure.

The wallet application 413 may locally cache on the client device 100 certain types of data in order to operate as described. This can include one or more user identifiers 419, one or more payment credentials 423, and/or a transaction history 426 of the user. Other data can also be cached by the wallet application 413 according to various embodiments of the present disclosure.

A user identifier 419 is any identifier that can uniquely identify a user or individual with respect to another individual. User identifiers 419 can be personally identifying, anonymous, or pseudonymous, depending on the type of data used and/or the nature of its use. In some instances, a user identifier 419 can be a single piece or instance of data. For example, a payment account number (e.g., credit card number, debit card number, bank account number, etc.), government identification number, cellular telephone number, or email address often have a one-to-one correspondence with individual users. In other instances, a user identifier 419 can be a tuple of data. For example, many people can share the same first and last name, but it is highly unlikely that two people with the same first and last name would also share the same date of birth or other item of information.

Moreover, multiple user identifiers 419 could be stored or cached by the wallet application 413. This could be done to allow the wallet application 413 to interact with multiple merchant rewards programs, as further discussed. For example, one merchant rewards program could be configured to use one type of user identifier 419 for individual members of the rewards program, while another merchant rewards program could be configured to use another type of user identifier 419 for individual members of the rewards program.

A payment credential 423 can represent information necessary to make a payment using a payment instrument (e.g., checking account, credit card, debit card, stored-value card, etc.). For example, a payment credential 423 could include the account number, expiration date, security code (e.g., card security code (CSC); card verification value (CVV); etc.), billing address, and/or name of the account owner. In some instances, these values could be tokenized or virtualized to protect the security of underlying payment instrument. For example, rather than store the actual credit card number, a virtual credit card number (sometimes referred to as a “payment token” or “token”) could be stored as part of the payment credential 423. In some instances, multiple payment credentials 423 could be cached by the wallet application 413, such as when a user has multiple credit or debit cards associated with his or her name (e.g., because he or she has multiple personal credit or debit cards linked to his or her name; is an authorized user of one or more credit cards or debit cards; a combination thereof; etc.).

The transaction history 426 can represent a history of transactions made using the wallet application 143 or by individual payment credentials 423. In some implementations, the most recent transactions could be stored locally (e.g., the last 30 days, 60 days, etc.) in order to provide the user with the ability to see his or her most recent transactions. These most recent transactions could also be stored or cached to facilitate the enrollment process with a merchant rewards program, as discussed later. The previous transactions made by the user can include purchases, returns, and/or credits made by the user. Individual transactions in the transaction history 426 can be linked to respective payment credentials 423 used to make the transaction.

The PoS terminal 103 can represent any physical, hosted, or virtual terminal operable by a merchant that can interact with the client device 100 using a wireless communication protocol (e.g., NFC, UWB, BLUETOOTH, etc.) to authorize a payment for a transaction. A PoS terminal 103 may be referred to as a credit card machine, card reader, PIN pad, or payment terminal. Examples of PoS terminals 103 include readers that communicate with a mobile application on a mobile device (e.g., smartphone, tablet, etc.), portable PoS terminals 103 (e.g., handheld credit card machines), and dedicated or standalone PoS terminals 103 (e.g., countertop readers integrated with a cash register).

The PoS radio 429 can represent any wireless transmitter or radio that is configured to communicate with the client radio 416 of a client device 100. In some implementations, a PoS terminal 103 can have separate PoS radios 429 to communicate using different wireless protocols or mediums. For example, even though both IEEE 802.11 wireless networks (i.e., WI-FI) and BLUETOOTH operate on the same 2.4 Ghz frequencies, the PoS terminal 103 could have separate radios and chipsets for communicating via WI-FI and BLUETOOTH. In other examples, however, a single PoS radio 429 could be used to communicate using WI-FI and BLUETOOTH. Similarly, separate PoS radios 429 or the same PoS radio 429 could be used to communicate using other wireless communications methodologies (e.g., NFC, UWB, etc.). Therefore, while only a PoS radio 429 is depicted in FIG. 4 to simplify the drawings, a PoS terminal 103 could have one or more PoS radios 429 as appropriate for different embodiments or implementations of a PoS terminal 103.

The PoS application 433 can represent any application installed on the PoS terminal 103 to authorize and process a payment for a transaction. Accordingly, the PoS application 433 could be configured to communicate with the wallet application 413 of the client device 100 using the PoS radio 429 to obtain the payment credential 423 and any other necessary information to process and authorize the payment. This can include determining whether the user of the wallet application 413 is a member of a rewards program of the merchant operating the PoS terminal 103 and/or enrolling the user into the rewards program of the merchant, as discussed later.

Various applications or other functionality can be executed in the computing environments, such as the merchant computing environment 403 and/or the issuer computing environment 406. These components can include a rewards service 436 executed by the merchant computing environment 403 and a user management service 439 executed by the issuer computing environment 406.

Also, various data is stored in data stores that are accessible to the computing environments, such as the merchant data store 443 and the issuer data store 446. The merchant data store 443 and the issuer data store 446 can be representative of a plurality of data stores, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the merchant data store 443 and the issuer data store 446 is associated with the operation of the various applications or functional entities described below. For example, one or more user rewards accounts 449 and one or more offers 451 can be stored in the merchant data store 443, while one or more user accounts 453 can be stored in the issuer data store 446.

A user rewards account 449 can represent an individual user who is enrolled in the merchant rewards program of a merchant, such as the merchant operating the PoS terminal 103. Accordingly, a user rewards account 449 can include information such as a user identifier 419 to distinguish between individual members and a rewards history 456 representing the user's history with the rewards program (e.g., eligible transactions, awards, redemptions, etc.)

An offer 451 can represent any offer, incentive, or discount that the merchant could make available to customers. Individual offers 451 could be tied to specific items (e.g., drinks), stock keeping units (SKUs) (e.g., six-packs of 12-ounce cans of COCA-COLA®), customers (e.g., rewards program members), or events (e.g., enrollment in the rewards program; holidays; user birthdays; rewards enrollment anniversaries; etc.).

A user account 453 can represent information associated with a user who is a customer of an issuer of a payment credential 423. Accordingly, the user account 453 can include one or more respective user identifiers 419 of the user, one or more payment credentials 423 issued to or linked to the user, and/or the transaction history 426 detailing the previous transactions (e.g., purchases, returns, and/or credits) made by the user. Individual transactions in the transaction history 426 can be linked to respective payment credentials 423 used to make the transaction.

The rewards service 436 can be executed to manage a merchant rewards program on behalf of a merchant. Accordingly, the rewards service 436 can be executed to manage enrollment of new users in the merchant rewards program (e.g., by creating new user rewards accounts 449) and determine the status of new, existing, or prospective users (e.g., by determining if someone has been previously enrolled or is currently enrolled). The rewards service 436 can also be executed to search for and identify offers 451 for enrolled members of the merchant rewards program.

The user management service 439 can be executed to manage data related to users of the wallet application 413 or customers who have been issued a payment credential 423. The user management service 439 can be executed to verify information about existing users or to respond to requests for information about current or previous users of the wallet application 413 or current or previous holders of individual payment credential(s) 423 issued to the user(s).

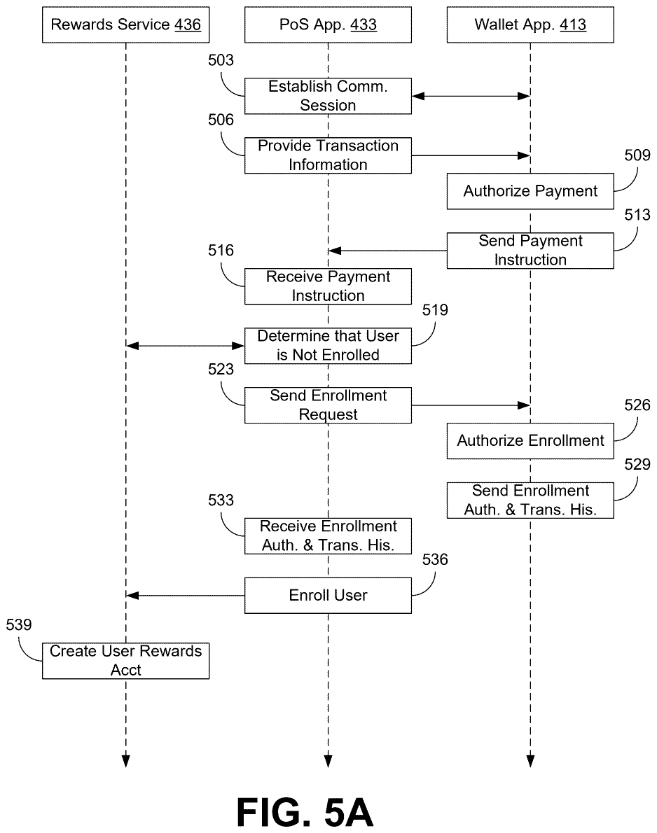

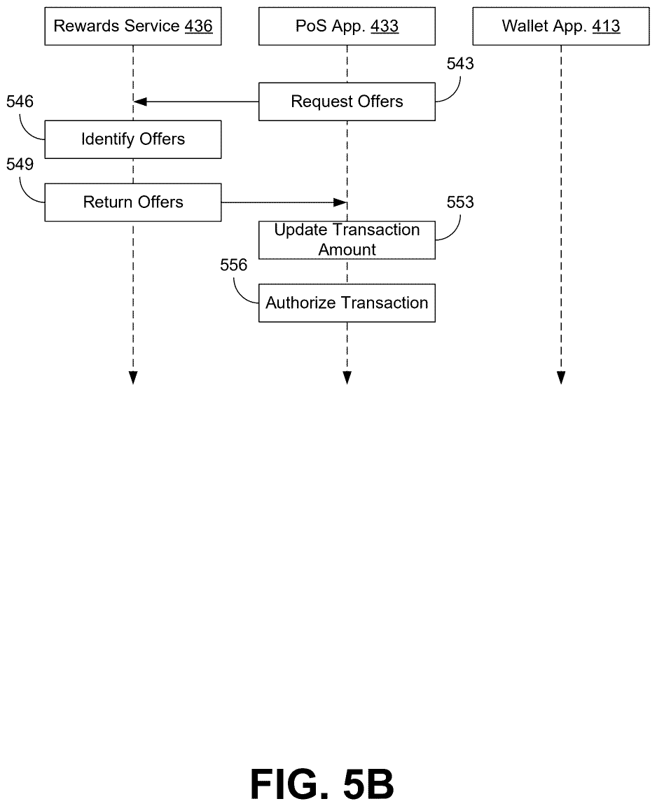

Referring next to FIGS. 5A and 5B, shown are sequence diagrams that provide one example of the interactions between the wallet application 413, the PoS application 433, and the rewards service 436. The sequence diagrams of FIGS. 5A and 5B provide merely an example of the many different types of functional arrangements that can be employed to implement the operations of the depicted portions of the wallet application 413, the PoS application 433, and the rewards service 436. As an alternative, the sequence diagrams of FIGS. 5A and 5B can be viewed as depicting an example of elements of a method implemented within the network environment 400.

Beginning with block 503, the PoS application 433 can cause the PoS terminal 103 to establish a direct communication session with the wallet application 413 of the client device 100. For example, the PoS application 433 could cause the PoS terminal 103 to establish an NFC session with the client device 100 to facilitate communication between the PoS application 433 and the wallet application 413. This could occur, for example, in response to the PoS radio 429 detecting the presence of the client radio 416 and signaling to the POS application 433 that the client device 100 is in proximity to the PoS terminal 103. As previously discussed, this could occur in response to the PoS application 433 causing the PoS terminal 103 to prompt a user to make a payment for a transaction, such as a purchase of goods or services with the merchant operating the PoS terminal 103.

Moving on to block 506, the PoS application 433 can provide information about the transaction to the wallet application 413 via the direct communication session (e.g., NFC session) established at block 503. This information can include the amount of the transaction, merchant identifier for the transaction, etc. Other information can also be provided by the PoS application 433 in response to a request from the wallet application 413 for additional information about the transaction.

Next, at block 509, the wallet application 413 can prompt the user of the client device 100 to authorize payment for the transaction. For example, the wallet application 413 could show on the display 106 of the client device the amount of the transaction, the identity of the merchant, and/or other information. The wallet application 413 could also prompt the user to select a payment credential 423 to use to fund or otherwise pay for the transaction. The wallet application 413 could also obtain the user's confirmation to proceed with the transaction with the identified merchant for the amount specified using the selected payment credential 423.

Then, at block 513, the wallet application 413 can return a payment instruction to the PoS application 433. The payment instruction can include information about the payment credential 423 to be used for to pay for the transaction. The payment instruction can also include one or more user identifiers 419 that the user of the wallet application 413 has previously chosen to share with the wallet application 413 for the purpose of sharing with merchants. Accordingly, at block 516, the PoS application 433 can receive the payment instruction from the PoS application 433.

Proceeding to block 519, the PoS application 433 can determine whether the user of the wallet application 413 is enrolled with a merchant rewards program of the merchant operating the PoS terminal 103. For example, the PoS application 433 could send a search query to the rewards service 436. The search query could include the user identifier(s) 419 received sent by the wallet application 413 at block 513 and received at block 516. The rewards service 436 could search for a user rewards account 449 in the merchant data store 443 with a user identifier(s) 419 that match the user identifier(s) 419 submitted in the search query by the PoS application 433. If a matching user rewards account 449 is present in the merchant data store 443, then the rewards service 436 can return a response to the PoS application 433 indicating that the user of the wallet application 413 is already enrolled with the rewards program of the merchant. Likewise, if a matching user rewards account 449 is not present in the merchant data store 443, then the rewards service 436 can return a response to the PoS application 433 indicating that the user of the wallet application 413 is not enrolled with the rewards program of the merchant.

Moving on to block 523, in response to a determination by the PoS application 433 that the user of the wallet application 413 is not currently enrolled with the merchant rewards program, the PoS application 433 can send an enrollment request to the wallet application 413. The enrollment request can include information such as benefits, terms, and conditions of the rewards program (which can be represented as uniform resource locators (URLs) that link to web pages or views where the benefits, terms, and conditions can be viewed or retrieved). In some embodiments, the PoS application 433 can simultaneously show on a display of the PoS terminal 103 that the user is being requested to join the merchant rewards program and that the user can accept or decline the invitation using the wallet application 413 on his or her client device 100.

Next, at block 526, the wallet application 413 can authorize enrollment of the user in the merchant rewards program. For example, such as the example previously depicted in FIG. 2, the wallet application 413 could show a prompt on the display 106 of the client device 100. The prompt could ask the user if he or she wishes to enroll in the merchant rewards program. The user can then choose to enroll or decline to enroll in the merchant rewards program.

If the user chose to enroll in the merchant rewards program at block 526, then the wallet application can send an enrollment authorization or confirmation message to the PoS application 433 at block 529, which would be received by the PoS application at block 533. The enrollment authorization or confirmation message can serve as an acknowledgement or instruction that the PoS application 433 should enroll the user of the wallet application 413 with the merchant rewards program. However, if the user chose not to enroll in the merchant rewards program, then the enrollment authorization or confirmation message could indicate that the user declined to enroll.

In the embodiment depicted in FIG. 5A, if the user has elected to enroll in the merchant rewards program, then the wallet application 413 can also provide a transaction history 426 to the PoS application 433 at block 529, which would be received by the PoS application at block 533. This could be done, for example, in order to provide the merchant with a list of previous transactions with the merchant for which the user could receive awards, rewards, or other incentives. Accordingly, the wallet application 413 could search for one or more transactions cached locally on the client device 100 where the merchant identifier of the merchant in a previous transaction matches the merchant identifier specified in the transaction information provided by the PoS application 433 at block 506. Alternatively, the wallet application 413 could send a request to the user management service 439 for a transaction history 426, such as a list of transactions stored in the issuer data store 446 where the merchant identifier of the merchant in a previous transaction matches the merchant identifier specified in the transaction information provided by the PoS application 433 at block 506. The user management service 439 could search for any matching transactions in the transaction history 426 of the user account 453 that matches the user identifier 419 of the user of the wallet application 413 and return any matching transactions to the wallet application 413. The wallet application 413 could then provide the matching transactions returned by the user management service 439 to the PoS application 433.

Proceeding to block 533, the PoS application 433 can receive the enrollment authorization and potentially the transaction history 426. The POS application 433 can then determine whether the user elected to enroll in the merchant rewards program or declined to enroll. If the user elected to enroll, then PoS application 433 can proceed to block 536. However, if the user declined to enroll, then the PoS application can skip to block 556, where the PoS application 433 would authorize the transaction for payment.

Moving on to block 536, the PoS application 433 can enroll the user of the wallet application 413 with the merchant rewards program. This can be done, for example, by instructing the rewards service 436 to create a new account representing the user of the wallet application 413. The message sent by the PoS application 433 to the rewards service 436 can include the user identifier(s) 419 provide by the wallet application at block 513, as well as any other information requested or required by the rewards program and authorized to be shared by the user at block 526 (e.g., sharing payment credential(s) 423).

Next, at block 539, the rewards service 436 can create a new user rewards account 449 to represent the user of the wallet application 413. The new user rewards account 449 can include the information provided at block 536 (e.g., the user identifier(s) 419 and potentially other information).

Then, at block 543, the PoS application 433 can request any offers 451 from the rewards service 436 that might be applicable to the transaction. For example, merchant rewards programs members might have exclusive or specific offers 451 available (e.g., 10% off first transaction after enrolling with the rewards program; 20% off one full-price item; buy-two items, get-one free; rewards points earned from prior transactions in the transaction history 426 that could be applied for a discount; etc.). The request for offers 451 could include information about the transaction (e.g., SKUs for individual items to be purchased; prices of the individual items; payment credential 423 being used; etc.) so that the most relevant offers 451 could be identified.

Proceeding to block 546, the rewards service 436 can search for any matching offers 451. For example, the rewards service 436 could search for offers 451 based on the status of the transaction (e.g., is there an offer applicable for a first transaction after enrollment in the rewards program). As another example, the rewards service 436 could search for offers 451 based on the amount of the transaction (e.g., $10 USD off transactions of $50 USD or more). The rewards service 436 could also search for offers 451 based on individual SKUs listed in the transactions (e.g., 50% off COCA-COLA® products). As another example, the rewards service 436 could search for offers 451 based on the payment credential 423 to be used to pay for the transaction (e.g., $10 off $100 or more when paying with AMERICAN EXPRESS).

Next, at block 549, the rewards service 436 can return any offers 451 identified at block 546 to the PoS application 433.

Then, at block 553, the PoS application 433 can update the transaction amount to reflect any offers 451 identified at block 546 by the rewards service 436 and returned to the PoS application at block 549. In some implementations, the new amount could be shown on a display of the PoS terminal 103 by the PoS application 433. In some implementations, the PoS application 433 could ask for the user of the wallet application 413 consent or otherwise authorize the transaction at the new amount. In these implementations, the PoS application 433 and the wallet application 413 could repeat some or all of the operations of blocks 506-516 to affirm the user's consent and approval. In other implementations, because the transaction will be for a lower amount than originally authorized after any identified offers 451 have been applied, the user's consent to the lower amount could be presumed or assumed.

Subsequently, at block 556, the PoS application 433 can authorize the transaction for payment. For example, the PoS application 433 could submit a transaction authorization request to a payment network associated with the payment credential 423.

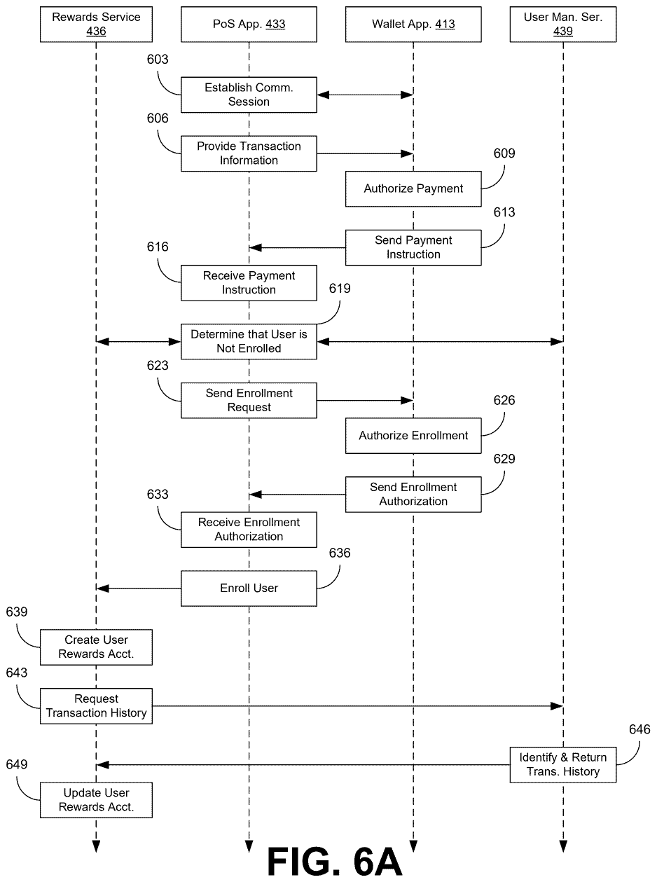

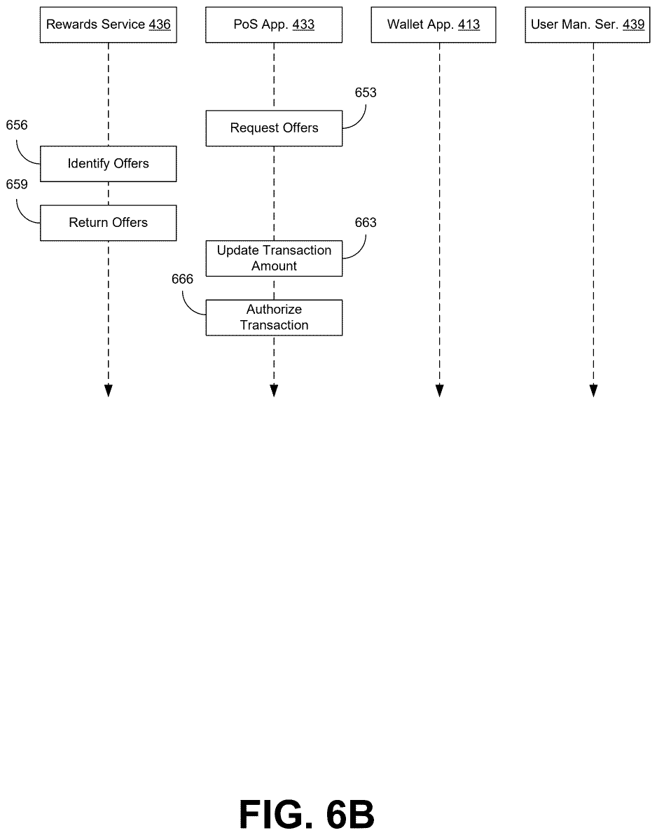

Referring next to FIG. 6, shown is a sequence diagram that provides one example of the interactions between the wallet application 413, the PoS application 433, the rewards service 436, and the user management service 439. The sequence diagram of FIG. 6 provides merely an example of the many different types of functional arrangements that can be employed to implement the operations of the depicted portions of the wallet application 413, the PoS application 433, the rewards service 436, and the user management service 439. As an alternative, the sequence diagram of FIG. 6 can be viewed as depicting an example of elements of a method implemented within the network environment 400.

Beginning with block 603, the PoS application 433 can cause the PoS terminal 103 to establish a direct communication session with the wallet application 413 of the client device 100. For example, the PoS application 433 could cause the PoS terminal 103 to establish an NFC session with the client device 100 to facilitate communication between the PoS application 433 and the wallet application 413. This could occur, for example, in response to the PoS radio 429 detecting the presence of the client radio 416 and signaling to the POS application 433 that the client device 100 is in proximity to the PoS terminal 103. As previously discussed, this could occur in response to the PoS application 433 causing the PoS terminal 103 to prompt a user to make a payment for a transaction, such as a purchase of goods or services with the merchant operating the PoS terminal 103.

Moving on to block 606, the PoS application 433 can provide information about the transaction to the wallet application 413 via the direct communication session (e.g., NFC session) established at block 503. This information can include the amount of the transaction, merchant identifier for the transaction, etc. Other information can also be provided by the PoS application 433 in response to a request from the wallet application 413 for additional information about the transaction.

Next, at block 609, the wallet application 413 can prompt the user of the client device 100 to authorize payment for the transaction. For example, the wallet application 413 could show on the display 106 of the client device the amount of the transaction, the identity of the merchant, and/or other information. The wallet application 413 could also prompt the user to select a payment credential 423 to use to fund or otherwise pay for the transaction. The wallet application 413 could also obtain the user's confirmation to proceed with the transaction with the identified merchant for the amount specified using the selected payment credential 423.

Then, at block 613, the wallet application 413 can return a payment instruction to the PoS application 433. The payment instruction can include information about the payment credential 423 to be used for to pay for the transaction. The payment instruction can also include one or more user identifiers 419 that the user of the wallet application 413 has previously chosen to share with the wallet application 413 for the purpose of sharing with merchants. Accordingly, at block 616, the PoS application 433 can receive the payment instruction from the PoS application 433.

Proceeding to block 619, the PoS application 433 can determine whether the user of the wallet application 413 is enrolled with a merchant rewards program of the merchant operating the PoS terminal 103. This could be done in a number of ways.

For example, the PoS application 433 could send a search query to the rewards service 436. The search query could include the user identifier(s) 419 received sent by the wallet application 413 at block 613 and received at block 616. The rewards service 436 could search for a user rewards account 449 in the merchant data store 443 with a user identifier(s) 419 that match the user identifier(s) 419 submitted in the search query by the PoS application 433. If a matching user rewards account 449 is present in the merchant data store 443, then the rewards service 436 can return a response to the PoS application 433 indicating that the user of the wallet application 413 is already enrolled with the rewards program of the merchant. Likewise, if a matching user rewards account 449 is not present in the merchant data store 443, then the rewards service 436 can return a response to the PoS application 433 indicating that the user of the wallet application 413 is not enrolled with the rewards program of the merchant.

As another example, the PoS application 433 or rewards service 436 could send the payment credential 423 (e.g., a payment card number or token) to the user management service 439. In response, the user management service 439 could search for and return additional user identifier(s) 419 associated with the payment credential 423. For example, the user management service 439 could provide additional email addresses or telephone numbers associated with a user. The rewards service 436 could then search for a user rewards account 449 in the merchant data store 443 that matches the additional user identifier(s) 419. If a matching user rewards account 449 is present in the merchant data store 443, then the rewards service 436 can return a response to the PoS application 433 indicating that the user of the wallet application 413 is already enrolled with the rewards program of the merchant. Likewise, if a matching user rewards account 449 is not present in the merchant data store 443, then the rewards service 436 can return a response to the PoS application 433 indicating that the user of the wallet application 413 is not enrolled with the rewards program of the merchant.

This second example could be performed in order to leverage the additional information that might be available to the issuer of the payment credential 423 or provider of the wallet application 413. For example, someone could have a new cellular phone number entered as a user identifier 419 in the wallet application 413, but had previously enrolled in the merchant rewards program with an older cellular phone number. By requesting additional user identifiers 419 from the user management service 439, the rewards service 436 would be able to identify a previously enrolled user who has updated his or her cellular phone number. This same example could be used for other types of user identifiers 419 as well.

Moving on to block 623, in response to a determination by the PoS application 433 that the user of the wallet application 413 is not currently enrolled with the merchant rewards program, the PoS application 433 can send an enrollment request to the wallet application 413. The enrollment request can include information such as benefits, terms, and conditions of the rewards program (which can be represented as uniform resource locators (URLs) that link to web pages or views where the benefits, terms, and conditions can be viewed or retrieved). In some embodiments, the PoS application 433 can simultaneously show on a display of the PoS terminal 103 that the user is being requested to join the merchant rewards program and that the user can accept or decline the invitation using the wallet application 413 on his or her client device 100.

Next, at block 626, the wallet application 413 can authorize enrollment of the user in the merchant rewards program. For example, such as the example previously depicted in FIG. 2, the wallet application 413 could show a prompt on the display 106 of the client device 100. The prompt could ask the user if he or she wishes to enroll in the merchant rewards program. The user can then choose to enroll or decline to enroll in the merchant rewards program.

If the user chose to enroll in the merchant rewards program at block 626, then the wallet application can send an enrollment authorization or confirmation message to the PoS application 433 at block 629, which would be received by the PoS application at block 633. The enrollment authorization or confirmation message can serve as an acknowledgement or instruction that the PoS application 433 should enroll the user of the wallet application 413 with the merchant rewards program. However, if the user chose not to enroll in the merchant rewards program, then the enrollment authorization or confirmation message could indicate that the user declined to enroll.

Proceeding to block 633, the PoS application 433 can receive the enrollment authorization. The PoS application 433 can then determine whether the user elected to enroll in the merchant rewards program or declined to enroll based on the contents of the enrollment authorization. If the user elected to enroll, then PoS application 433 can proceed to block 636. However, if the user declined to enroll, then the PoS application can skip to block 666, where the PoS application 433 would authorize the transaction for payment.

Next, at block 636, the PoS application 433 can enroll the user of the wallet application 413 with the merchant rewards program. This can be done, for example, by instructing the rewards service 436 to create a new account representing the user of the wallet application 413. The message sent by the PoS application 433 to the rewards service 436 can include the user identifier(s) 419 provide by the wallet application at block 613, as well as any other information requested or required by the rewards program and authorized to be shared by the user at block 626 (e.g., sharing payment credential(s) 423).

Then, at block 639, the rewards service 436 can create a new user rewards account 449 to represent the user of the wallet application 413. The new user rewards account 449 can include the information provided at block 536 (e.g., the user identifier(s) 419 and potentially other information).

Proceeding to block 643, the rewards service 436 can request a transaction history 426 for the user from the user management service 439. This could be done, for example, in order to provide the merchant with a list of previous transactions with the merchant for which the user could receive awards, rewards, or other incentives. The request could include a merchant identifier of the merchant operating the PoS terminal 103 or merchant rewards program.

Accordingly, at block 646, the user management service 439 could search for any matching transactions in the transaction history 426 of the user account 453 that matches the user identifier 419 of the user of the wallet application 413. The user management service 439 could then return any matching transactions to the rewards service 436.

Moving on to block 649, the rewards service 436 can update the user rewards account 449 created at block 639 to include the transaction history 426 provided by the user management service 439 at block 646.

Next, at block 653, the PoS application 433 can request any offers 451 from the rewards service 436 that might be applicable to the transaction. For example, merchant rewards programs members might have exclusive or specific offers 451 available (e.g., 10% off first transaction after enrolling with the rewards program; 20% off one full-price item; buy-two items, get-one free; rewards points earned from prior transactions in the transaction history 426 that could be applied for a discount; etc.). The request for offers 451 could include information about the transaction (e.g., SKUs for individual items to be purchased; prices of the individual items; payment credential 423 being used; etc.) so that the most relevant offers 451 could be identified.

Then, at block 656, the rewards service 436 can search for any matching offers 451. For example, the rewards service 436 could search for offers 451 based on the status of the transaction (e.g., is there an offer applicable for a first transaction after enrollment in the rewards program). As another example, the rewards service 436 could search for offers 451 based on the amount of the transaction (e.g., $10 USD off transactions of $50 USD or more). The rewards service 436 could also search for offers 451 based on individual SKUs listed in the transactions (e.g., 50% off COCA-COLA® products). As another example, the rewards service 436 could search for offers 451 based on the payment credential 423 to be used to pay for the transaction (e.g., $10 off $100 or more when paying with AMERICAN EXPRESS).

Proceeding to block 659, the rewards service 436 can return any offers 451 identified at block 726 to the PoS application 433.

Moving on to block 663, the PoS application 433 can update the transaction amount to reflect any offers 451 identified at block 656 by the rewards service 436 and returned to the PoS application at block 659. In some implementations, the new amount could be shown on a display of the PoS terminal 103 by the PoS application 433. In some implementations, the PoS application 433 could ask for the user of the wallet application 413 consent or otherwise authorize the transaction at the new amount. In these implementations, the PoS application 433 and the wallet application 413 could repeat some or all of the operations of blocks 606-616 to affirm the user's consent and approval. In other implementations, because the transaction will be for a lower amount than originally authorized after any identified offers 451 have been applied, the user's consent to the lower amount could be presumed or assumed.

Then, at block 666, the PoS application 433 can authorize the transaction for payment. For example, the PoS application 433 could submit a transaction authorization request to a payment network associated with the payment credential 423.

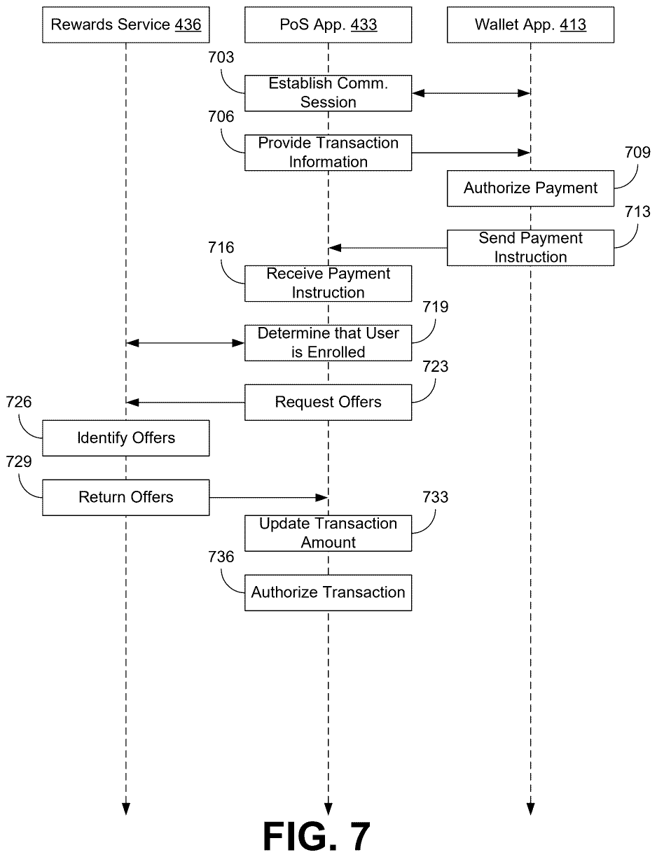

Referring next to FIG. 7, shown is a sequence diagram that provides one example of the interactions between the wallet application 413, the PoS application 433, and the rewards service 436. The sequence diagram of FIG. 7 provides merely an example of the many different types of functional arrangements that can be employed to implement the operations of the depicted portions of the wallet application 413, the PoS application 433, and the rewards service 436. As an alternative, the sequence diagram of FIG. 7 can be viewed as depicting an example of elements of a method implemented within the network environment 400.

Beginning with block 703, the PoS application 433 can cause the PoS terminal 103 to establish a direct communication session with the wallet application 413 of the client device 100. For example, the PoS application 433 could cause the PoS terminal 103 to establish an NFC session with the client device 100 to facilitate communication between the PoS application 433 and the wallet application 413. This could occur, for example, in response to the PoS radio 429 detecting the presence of the client radio 416 and signaling to the PoS application 433 that the client device 100 is in proximity to the PoS terminal 103. As previously discussed, this could occur in response to the PoS application 433 causing the PoS terminal 103 to prompt a user to make a payment for a transaction, such as a purchase of goods or services with the merchant operating the PoS terminal 103.

Moving on to block 706, the PoS application 433 can provide information about the transaction to the wallet application 413 via the direct communication session (e.g., NFC session) established at block 503. This information can include the amount of the transaction, merchant identifier for the transaction, etc. Other information can also be provided by the PoS application 433 in response to a request from the wallet application 413 for additional information about the transaction.

Next, at block 709, the wallet application 413 can prompt the user of the client device 100 to authorize payment for the transaction. For example, the wallet application 413 could show on the display 106 of the client device the amount of the transaction, the identity of the merchant, and/or other information. The wallet application 413 could also prompt the user to select a payment credential 423 to use to fund or otherwise pay for the transaction. The wallet application 413 could also obtain the user's confirmation to proceed with the transaction with the identified merchant for the amount specified using the selected payment credential 423.

Then, at block 713, the wallet application 413 can return a payment instruction to the PoS application 433. The payment instruction can include information about the payment credential 423 to be used for to pay for the transaction. The payment instruction can also include one or more user identifiers 419 that the user of the wallet application 413 has previously chosen to share with the wallet application 413 for the purpose of sharing with merchants. Accordingly, at block 716, the PoS application 433 can receive the payment instruction from the PoS application 433.

Proceeding to block 719, the PoS application 433 can determine whether the user of the wallet application 413 is enrolled with a merchant rewards program of the merchant operating the PoS terminal 103. For example, the PoS application 433 could send a search query to the rewards service 436. The search query could include the user identifier(s) 419 received sent by the wallet application 413 at block 713 and received at block 716. The rewards service 436 could search for a user rewards account 449 in the merchant data store 443 with a user identifier(s) 419 that match the user identifier(s) 419 submitted in the search query by the PoS application 433. If a matching user rewards account 449 is present in the merchant data store 443, then the rewards service 436 can return a response to the PoS application 433 indicating that the user of the wallet application 413 is already enrolled with the rewards program of the merchant. Likewise, if a matching user rewards account 449 is not present in the merchant data store 443, then the rewards service 436 can return a response to the PoS application 433 indicating that the user of the wallet application 413 is not enrolled with the rewards program of the merchant.

Moving on to block 723, in response to determining that the user is already enrolled with the merchant rewards program at block 719, the PoS application 433 can request any applicable offers 451 to the transaction for the user from the rewards service 436. For example, merchant rewards programs members might have exclusive or specific offers 451 available (e.g., 10% off first transaction after enrolling with the rewards program; 20% off one full-price item; buy-two items, get-one free; rewards points earned from prior transactions in the transaction history 426 that could be applied for a discount; etc.). The request for offers 451 could include information about the transaction (e.g., SKUs for individual items to be purchased; prices of the individual items; payment credential 423 being used; etc.) so that the most relevant offers 451 could be identified.

Next, at block 726, the rewards service 436 can search for any matching offers 451. For example, the rewards service 436 could search for offers 451 based on the status of the transaction (e.g., is there an offer applicable for a first transaction after enrollment in the rewards program). As another example, the rewards service 436 could search for offers 451 based on the amount of the transaction (e.g., $10 USD off transactions of $50 USD or more). The rewards service 436 could also search for offers 451 based on individual SKUs listed in the transactions (e.g., 50% off COCA-COLA® products). As another example, the rewards service 436 could search for offers 451 based on the payment credential 423 to be used to pay for the transaction (e.g., $10 off $100 or more when paying with AMERICAN EXPRESS).

Then, at block 729, the rewards service 436 can return any offers 451 identified at block 726 to the PoS application 433.

Proceeding to block 733, the PoS application 433 can update the transaction amount to reflect any offers 451 identified at block 726 by the rewards service 436 and returned to the PoS application at block 729. In some implementations, the new amount could be shown on a display of the PoS terminal 103 by the PoS application 433. In some implementations, the PoS application 433 could ask for the user of the wallet application 413 consent or otherwise authorize the transaction at the new amount. In these implementations, the PoS application 433 and the wallet application 413 could repeat some or all of the operations of blocks 706-716 to affirm the user's consent and approval. In other implementations, because the transaction will be for a lower amount than originally authorized after any identified offers 451 have been applied, the user's consent to the lower amount could be presumed or assumed.

Subsequently, at block 736, the PoS application 433 can authorize the transaction for payment. For example, the PoS application 433 could submit a transaction authorization request to a payment network associated with the payment credential 423.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

1. A system, comprising:
a point of sale (PoS) terminal comprising a processor and a memory; and
machine-readable instructions stored in the memory that, when executed by the processor, cause the PoS terminal to at least:
establish a near field communication (NFC) session with an NFC enabled client device to communicate with the NFC enabled client device, wherein the NFC session is established based at least in part on detecting that the NFC enabled client device is placed in proximity of the PoS terminal;
receive a payment instruction for a transaction from the NFC enabled client device, the payment instruction comprising a unique user identifier for a user of the NFC enabled client device;
determine, based at least in part on the unique user identifier, that a user of the NFC enabled client device is not enrolled in a merchant rewards program;
send to the NFC enabled client device a request to enroll in the merchant rewards program;
receive, from the NFC enabled client device, an enrollment authorization, wherein the enrollment authorization is authorized on the NFC enabled client device based at least in part on a response to a prompt displayed on the NFC enabled client device; and
enroll a user of the NFC enabled client device in the merchant rewards program based at least in part on the enrollment authorization received from the NFC enabled client device.

2. The system of claim 1, wherein the machine-readable instructions that cause the PoS terminal to enroll the user of the NFC enabled client device in the merchant rewards program further cause the PoS terminal to send the unique user identifier to a rewards service, wherein the rewards service is configured to create a user account for the rewards program that represents the user of the NFC enabled client device.

3. The system of claim 1, wherein
the unique user identifier is a payment credential; and
the machine-readable instructions that cause the PoS terminal to determine that the user of the NFC enabled client device is not enrolled in the merchant rewards program further cause the PoS terminal to at least:
send the payment credential to an issuer of the payment credential;
receive a second unique user identifier from the issuer, the second unique user identifier being associated with the payment credential; and
determine whether the second unique user identifier is associated with a user enrolled with the merchant rewards program.

4. The system of claim 1, wherein the machine-readable instructions further cause the PoS terminal to at least:
send an enrollment authorization to the NFC enabled client device, the enrollment authorization indicating that the user has been enrolled with the merchant rewards program; and
receive from the NFC enabled client device a record of one or more previous transactions with the merchant.

5. The system of claim 1, wherein the machine-readable instructions further cause the PoS terminal to at least:
request one or more offers associated with the transaction;
receive the one or more offers; and
update the transaction to reflect a new amount that is based at least in part on the one or more offers.

6. The system of claim 5, wherein
the payment instruction comprises a payment instrument; and
the machine-readable instructions further cause the PoS terminal to at least:
submit a transaction authorization request to a payment network associated with the payment instrument for the new amount.

7. The system of claim 5, wherein the machine-readable instructions further cause the computing device to at least send a request to the NFC enabled client device to authorize the new amount for the transaction.

8. A method, comprising:
establish a near field communication (NFC) session with an NFC enabled client device to communicate with the NFC enabled client device, wherein the NFC session is established based at least in part on detecting that the NFC enabled client device is placed in proximity of a PoS terminal;
receive a payment instruction for a transaction from the NFC enabled client device, the payment instruction comprising a unique user identifier for a user of the NFC enabled client device;
determine, based at least in part on the unique user identifier, that a user of the NFC enabled client device is not enrolled in a merchant rewards program;
send to the NFC enabled client device a request to enroll in the merchant rewards program;
receive, from the NFC enabled client device, an enrollment authorization, wherein the enrollment authorization is authorized on the NFC enabled client device based at least in part on a response to a prompt displayed on the NFC enabled client device; and
enroll a user of the NFC enabled client device in the merchant rewards program based at least in part on the enrollment authorization received from the NFC enabled client device.

9. The method of claim 8, wherein enrolling the user of the client device in the merchant rewards program further comprises sending the unique user identifier to a rewards service, wherein the rewards service is configured to create a user account for the rewards program that represents the user of the NFC enabled client device.

10. The method of claim 8, wherein
the unique user identifier is a payment credential; and
determining that the user of the NFC enabled client device is not enrolled in the merchant rewards program further cause the PoS terminal to at least:
send the payment credential to an issuer of the payment credential;
receive a second unique user identifier from the issuer, the second unique user identifier being associated with the payment credential; and
determine whether the second unique user identifier is associated with a user enrolled with the merchant rewards program.

11. The method of claim 8, further comprising:
sending an enrollment authorization to the NFC enabled client device, the enrollment authorization indicating that the user has been enrolled with the merchant rewards program; and
receiving from the NFC enabled client device a record of one or more previous transactions with the merchant.

12. The method of claim 8, further comprising:
requesting one or more offers associated with the transaction;
receiving the one or more offers; and
updating the transaction to reflect a new amount that is based at least in part on the one or more offers.

13. The method of claim 12, wherein
the payment instruction comprises a payment instrument; and
the method further comprises submitting a transaction authorization request to a payment network associated with the payment instrument for the new amount.

14. The method of claim 12, further comprising send a request to the NFC enabled client device to authorize the new amount for the transaction.

15. A non-transitory, computer-readable medium, comprising machine-readable instructions that, when executed by a processor of a point-of-sale (PoS) terminal, cause the PoS terminal to at least:
establish a near field communication (NFC) session with an NFC enabled client device to communicate with the NFC enabled client device, wherein the NFC session is established based at least in part on detecting that the NFC enabled client device is placed in proximity of the PoS terminal;
receive a payment instruction for a transaction from the NFC enabled client device, the payment instruction comprising a unique user identifier for a user of the NFC enabled client device;
determine, based at least in part on the unique user identifier, that a user of the NFC enabled client device is not enrolled in a merchant rewards program;
send to the NFC enabled client device a request to enroll in the merchant rewards program;
receive, from the NFC enabled client device, an enrollment authorization, wherein the enrollment authorization is authorized on the NFC enabled client device based at least in part on a response to a prompt displayed on the NFC enabled client device; and
enroll a user of the NFC enabled client device in the merchant rewards program based at least in part on the enrollment authorization received from the NFC enabled client device.

16. The non-transitory, computer-readable medium of claim 15, wherein the machine-readable instructions that cause the PoS terminal to enroll the user of the NFC enabled client device in the merchant rewards program further cause the PoS terminal to send the unique user identifier to a rewards service, wherein the rewards service is configured to create a user account for the rewards program that represents the user of the NFC enabled client device.

17. The non-transitory, computer-readable medium of claim 15, wherein
the unique user identifier is a payment credential; and
the machine-readable instructions that cause the PoS terminal to determine that the user of the NFC enabled client device is not enrolled in the merchant rewards program further cause the PoS terminal to at least:
send the payment credential to an issuer of the payment credential;
receive a second unique user identifier from the issuer, the second unique user identifier being associated with the payment credential; and
determine whether the second unique user identifier is associated with a user enrolled with the merchant rewards program.

18. The non-transitory, computer-readable medium of claim 15, wherein the machine-readable instructions further cause the PoS terminal to at least:
send an enrollment authorization to the NFC enabled client device, the enrollment authorization indicating that the user has been enrolled with the merchant rewards program; and
receive from the NFC enabled client device a record of one or more previous transactions with the merchant.

19. The non-transitory, computer-readable medium of claim 15, wherein the machine-readable instructions further cause the computing device to at least:
request one or more offers associated with the transaction;
receive the one or more offers; and
update the transaction to reflect a new amount that is based at least in part on the one or more offers.

20. The non-transitory, computer-readable medium of claim 19, wherein
the payment instruction comprises a payment instrument; and
the machine-readable instructions further cause the computing device to at least:
submit a transaction authorization request to a payment network associated with the payment instrument for the new amount.
